(19) United States
(12) Patent Application Publication
(10) Pub. No.: US 2004/0134446 A1
(43) Pub. Date: Jul. 15, 2004

(54) Dog toy

(76) Inventor: Steve Keller, Seattle, WA (US)

Correspondence Address: Clark A. Puntigam, Members of the Bar of the state of Washington, 2033 Sixth Avenue, Suite 1020, Seattle, WA, 98121, US

(21) Appl. No.: 10/340,243

(22) Filed: Jan. 10, 2003

(51) Int. Cl. A01K 29/00

(52) U.S. Cl. 119/707

(57) ABSTRACT

A dog toy having a central axle member and a pair of opposing rotating wheels wherein the entire exterior surface is covered with a flexible cover that is resistant to punctures.

### TECHNICAL FIELD

This invention relates to a dog toy, and more particularly to a dog toy having a central axle portion and a pair of opposing rotating wheels such that the toy may be easily tossed, rolled, and caught, providing many facets of entertainment. The toy is covered with a material that is flexible and resistant to punctures.

### BACKGROUND OF THE INVENTION

It is well known that some pets need constant attention, and, therefore, it is desirable to provide them with toys or other objects that will, because of their versatility, occupy the pet for an extended period of time, thereby requiring less attention by the pet's owner.

Toys have been provided to pets that can be thrown, rolled, chewed, fetched, or batted, and are in shapes and colors believed to be attractive to the target audience.

Prior art references known to the inventor, which may be relevant to the present patent application, include:

U.S. Pat. No. Design 281,816, granted to Cahn, Sr., et al, Dec. 17, 1985, discloses a massager in a roller, cylindrical form;

U.S. Pat. No. 5,191,856, granted to Gordon, Mar. 9, 1983, discloses an ANIMAL TOY, including a hollow central section containing a spring that holds a cap to each end. Deposited in the interior is a material that exhibits a positive sensory attraction to an animal;

U.S. Pat. No. 6,092,489, granted to Huettner et al, Jul. 25, 2000, discloses a DOG TOY, including a central shaft portion terminating in flexible end members into which may be placed tennis balls;

U.S. Pat. No. Design 253,373, granted to Celeste Nov. 6, 1979, discloses another ROLLING MASSAGER;

U.S. Pat. No. Design 427,391, granted to Gill Jun. 27, 2000, discloses a FLASHING DOG BONE CHEW TOY, with three separate wheel-like sections apparently fixedly secured to a shaft;

U.S. Pat. No. Design 427,389, granted to Baiera Jun. 27, 2000, discloses a PET ROLLER TOY, apparently to be pushed by a rodent-type animal; and

U.S. Pat. No. 6,216,640 B1, granted to Zelinger Apr. 17, 2001, discloses a bone-shaped plastic toy with a tubular central portion terminating in a pair of sockets formed of spring-like fingers that deflect outwardly to accept tennis balls.

### SUMMARY OF INVENTION

With the above-noted prior art in mind, it is a feature of the present invention to have a pair of opposing wheels that are freely rotatable on the shaft, enabling the toy to more easily roll when on the ground but still able to be thrown and chewed.

Another feature of the present invention is a pet toy fabricated of a material that is rigid so as to perform mechanically, but having a cover that is flexible and not brittle, enabling a pet to chew on the toy without damage to the teeth, and, since the material is also resistant to punctures, it is long-lasting.

Another feature of the present invention is the fact that the rotatable opposing wheels, mounted to a common shaft, are snap-fit for ease of construction and control of price.

### BRIEF DESCRIPTION OF THE DRAWINGS

FIG. 1 is an isometric view of the inventive dog toy.

FIG. 2 is an exploded view of the dog toy of FIG. 1.

FIG. 3 is a vertical sectional view through the center of the dog toy of FIG. 1.

FIG. 4 is an isometric view of an alternative embodiment of the dog toy of FIG. 1.

FIG. 5 is an exploded view of an alternate construction of the center shaft for the inventive dog toy.

### BEST MODE FOR CARRYING OUT THE INVENTION

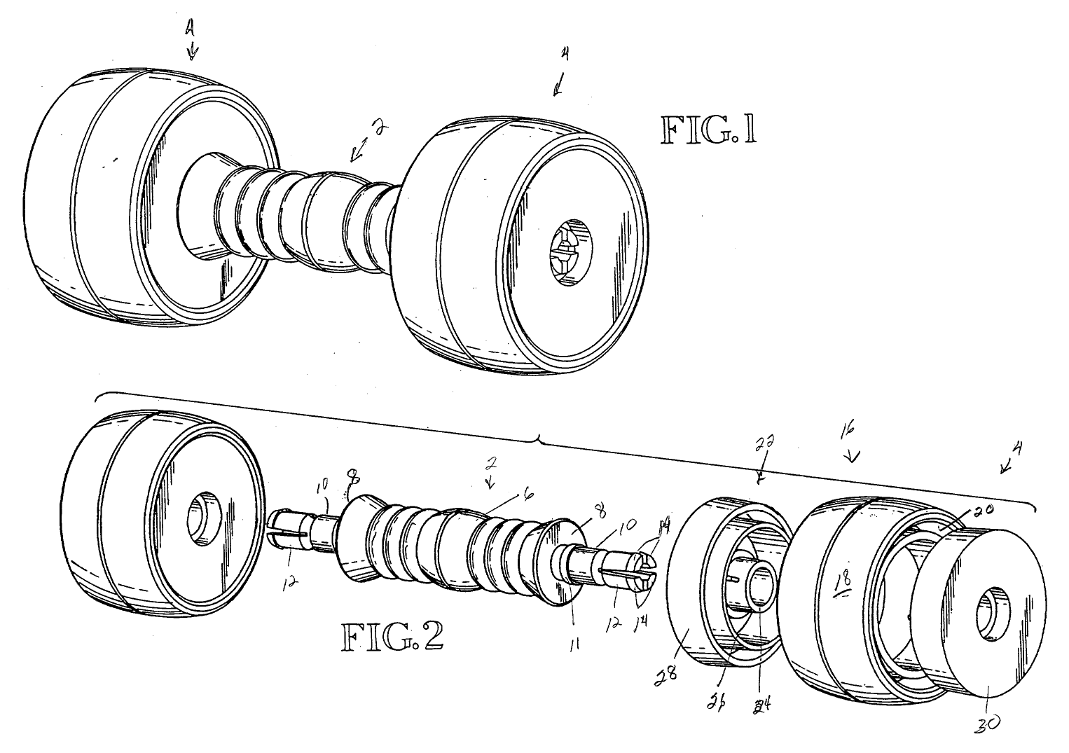

As best seen in FIG. 1, the inventive dog toy has the general configuration of an archetypical bone. The toy has a configured central shaft portion 2 having mounted thereon opposing rotatable wheels 4. The exterior surface of the entire toy is formed of a material that is compressible but resistant to punctures.

Reference is now had to FIG. 2, wherein the axle or shaft portion 2 includes the configured outer body portion 6 which terminates in a pair of flat, opposing, wheel-contacting surfaces 8 surrounding a more rigid cylindrical element 10 terminating in segmented, resilient, outwardly biased elements 12 having outwardly extending radial segments 14. The wheel 4 includes a main roller element 16 including an outer surface 18 and an axially extending circumferential groove 20. The wheel 4 is completed by an inner cap 22 which abuts the exterior surface of ridge 11 on surface 10 and includes a hub 24 protruding from an inwardly projecting circumferential ridge 26 and cylindrical outward outer surface 28. The outer cap 30 is constructed similarly to cap 22, as will be explained hereinafter.

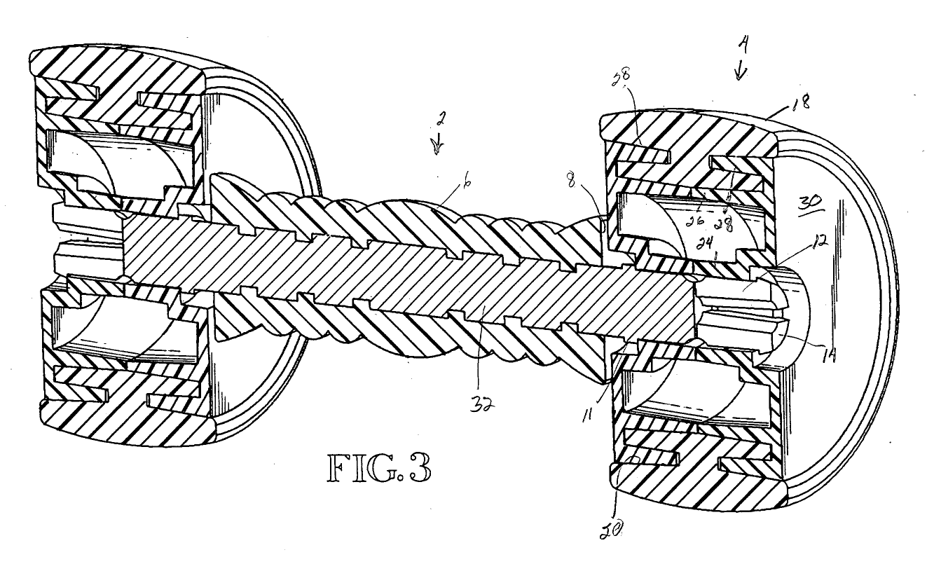

As seen in FIG. 3, the construction of the inventive toy includes a rigid axle member 2 having its central portion surrounded by a resilient, puncture-resistant outer surface 6 terminating in a flat surface as described hereinabove. Axle member 2 terminates in the snap-fit portion of 12 and 14, also described above. The inner cap member 22 and outer cap member 30 are pressed together into the interior ridges formed by wall 20 and the interior of the main roller element 4, and then the entire assemblage is snap-fit onto the ends of the axle, and the radially outward-extending ridges 14 retain the roller element 4 in position.

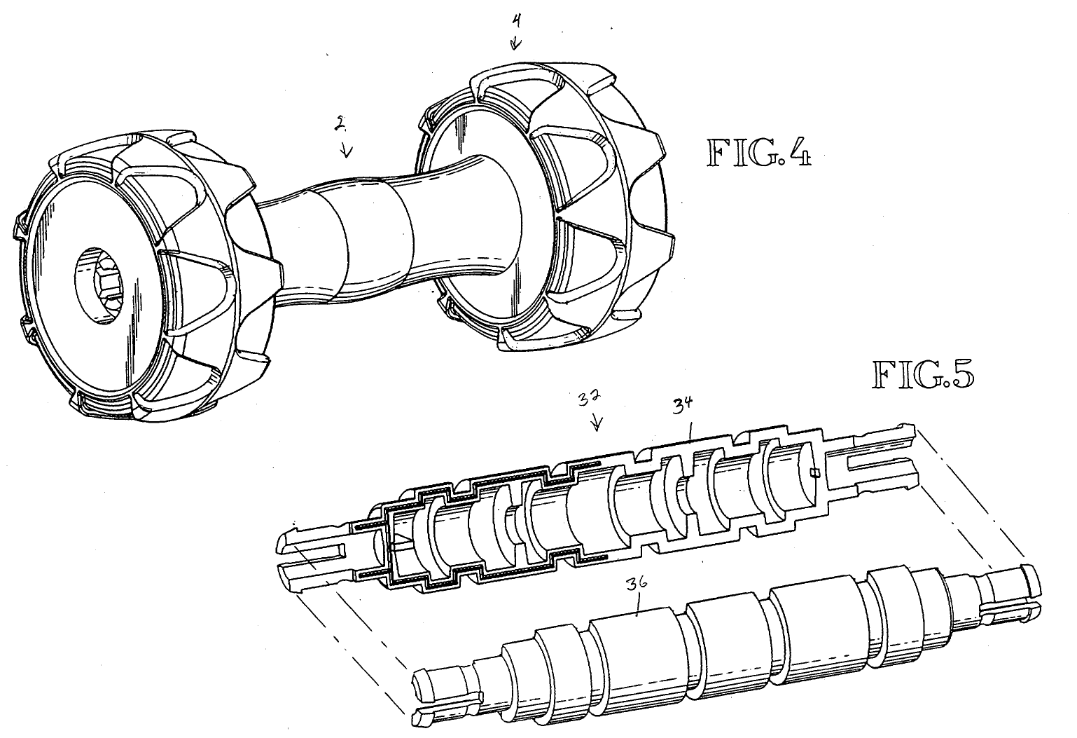

An alternate configuration is shown in FIG. 4, wherein the main body portion 2 has a simpler form, and the roller elements include tractor-like treads. Here again it is understood that the main body element core is of a rigid, resilient material, and the outer surfaces of 2 and 4 are of a less rigid, more resilient puncture-resistant material.

FIG. 5 depicts an alternate way of fabricating the main axle element 32, and it is divided into two identical halves, 34 and 36, cut along this axis of rotation, one of which has an outwardly projecting ridge element along its flat surface, and the other having a mating groove such that the elements may be quickly and easily aligned and secured during the fabrication process.

Thus, as can be seen, the present invention discloses a safe and useful toy that can be used in many fashions.

What is claimed:

1. A dog toy, comprising:
a central shaft member, including an exterior surface of a material that is compressible and puncture-resistant; and
a pair of rotatable end elements, said end elements including an exterior surface of a material that is compressible and puncture-resistant.

2. A dog toy as in claim 1, wherein the end elements are wheels supported upon bearings.

3. A dog toy as in claim 1, wherein the central shaft and the end elements are hollow.

4. A toy for pets that bounces, rolls, can be tossed, caught or chewed, comprising:
an elongated, hollow, cylindrical, flexible shaft member, including divided end portions, wherein each end portion includes an outwardly projecting compressible axle member; and
a pair of hollow, rotatable wheel members snap-fit to said axle member.

5. A toy as in claim 4, wherein the entire exterior (exposed) surface is of a material that is compressible and puncture-resistant.
